(19) United States
(12) Patent Application Publication
(10) Pub. No.: US 2002/0019696 A1
(43) Pub. Date: Feb. 14, 2002

(54) Vehicle commentary method and system

(76) Inventor: Jonathan Kruse, Auckland (NZ)

Correspondence Address: THOMAS R. VIGIL, VIGIL & ASSOCIATES, 826 SOUTH NORTHWEST HIGHWAY, BARRINGTON, IL, 60010, US

(21) Appl. No.: 09/864,021

(22) Filed: May 23, 2001

Related U.S. Application Data
(60) Provisional application No. 60/206,532, filed on May 23, 2000.

(51) Int. Cl. G01C 21/30; G01C 21/26

(52) U.S. Cl. 701/207; 701/211

(57) ABSTRACT

The invention relates to a method for providing commentary to one or more passengers in a moving vehicle including periodically or continuously determining the present location of the vehicle as the vehicle moves through a geographic area, assessing whether items of commentary related to different parts of the geographic area are available as the vehicle passes through different parts of the geographic area from a number of stored commentary items related to different parts of the geographic area and playing a commentary to the passenger(s) consisting of items form the stored items of commentary.

### FIELD OF INVENTION

The present invention relates to a method and apparatus for providing commentaries to passengers travelling in a vehicle based on the location of the vehicle.

### BACKGROUND

Vehicle location and route guiding systems have developed along side the development of global positioning systems (GPS). These systems use the output from at least three overhead satellites to determine the location of a receiver on the surface of the earth. GPS systems have found wide ranging applications from military vehicle positioning to tracking company trucks and taxi dispatch systems. Portable units suitable for trampers and cyclists have also been developed.

Passengers on organised tours in tour busses are generally provided with a commentary on places of interest by a tour guide or the bus driver. These commentaries generally coincide with the bus passing a place of interest. Because these commentaries are given to a group of people the individual preferences of members of the group cannot be taken into account.

### SUMMARY OF INVENTION

In broad terms in one aspect the invention comprises a method for providing commentary to one or more passengers in a moving vehicle including the steps of:

periodically or continuously determining the present location of the vehicle as the vehicle moves through or in a geographic area,

assessing whether items of commentary related to different parts of the geographic area are available as the vehicle passes through different parts of the geographic area, from a number of stored items of commentary related to different parts of the geographic area, and

playing a commentary to the passenger(s) consisting of a series of selected items from said stored items of commentary.

In broad terms in another aspect the invention comprises a system for providing commentary to one or more passengers in a moving vehicle including:

means arranged to periodically or continuously determine the present location of the vehicle as the vehicle moves through or in a geographic area,

means arranged to assess whether items of commentary related to different parts of the geographic area are available as the vehicle passes through different parts of the geographic area, from a number of stored items of commentary related to different parts of the geographic area, and

means arranged to play a commentary to the passenger(s) consisting of a series of selected items from said stored items of commentary.

Preferably the system is also arranged to play items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

In a further aspect the invention comprises a system for providing commentary to one or more passengers in a moving automobile, bus, motorhome, or air or marine craft, including means arranged to monitor the location of the vehicle as it travels through or in a geographic area, and means arranged to play a prerecorded commentary related to the current location of the vehicle to the passenger(s).

In the system and method of the invention the commentary includes discrete items of commentary information, the playing of each of which is separately initiated when the means arranged to monitor the location of the vehicle indicates that the vehicle is in a part of the geographic area to which an individual item of commentary information relates.

The commentary may include audio including voice, sound effects and music, visual presentation including still and moving images, real and/or graphical images or a synchronised combination of audio and visual commentaries.

An audio commentary may be provided trough speakers in the vehicle so that all passengers hear the same commentary. Alternatively passengers may be provided with individual speakers or headsets to allow the passengers to control the commentary delivery including the choice of listening to the commentary or not.

Preferably the means to determine the location of the vehicle is provided by global positioning system equipment.

### BRIEF DESCRIPTION OF THE DRAWINGS

A preferred form system and method of the invention will be further described with reference to the accompanying drawings by way of example only and without intending to be limiting, wherein:

FIG. 1 is a block diagram showing the major components of a commentary system of the invention,

FIG. 2 is a block diagram showing the major components of a commentary system of the invention especially adapted for rental cars and vans,

FIG. 3 is a block diagram showing the major components of a commentary system of the invention especially adapted for tour coaches,

FIG. 4 is a block diagram showing the major component of a commentary system of the invention especially adapted for tour coaches with individual headsets, and

FIG. 5 is a block diagram showing the major component of a commentary system of the invention especially adapted for tour coaches with individual headsets with a common video display.

### DETAILED DESCRIPTION OF PREFERRED FORMS

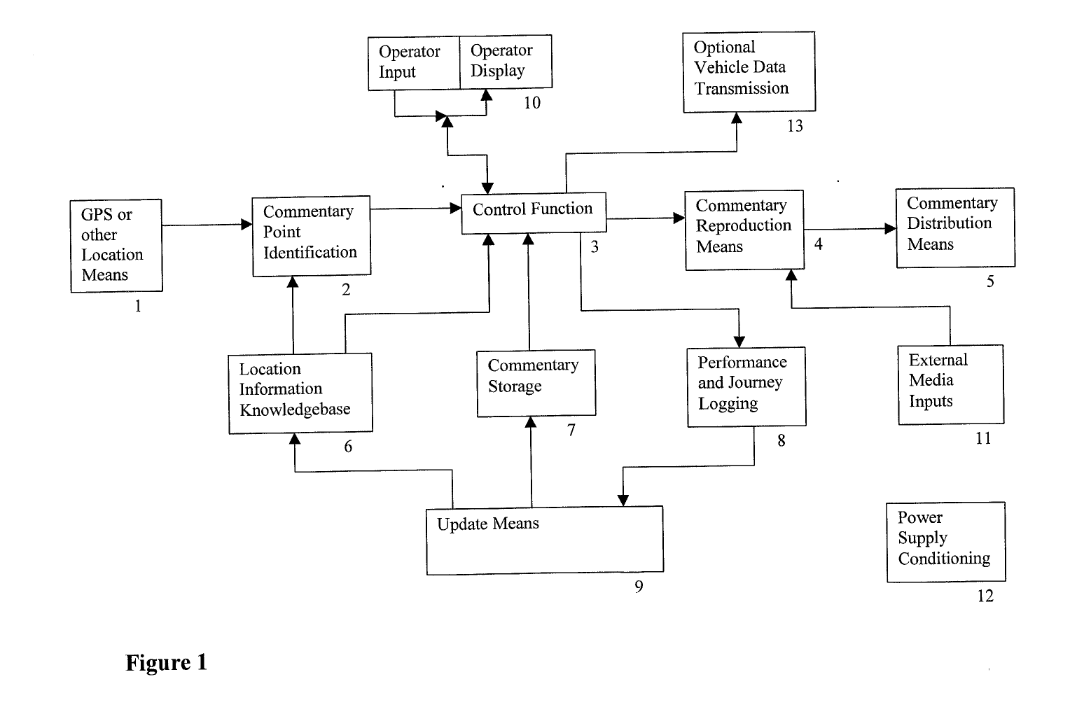

FIG. 1 shows the main components of the on-board commentary system. The components include vehicle location information receiving means, commentary point identification means, location information knowledge base, commentary storage, commentary reproduction and distribution means. Some of the components such as the commentary point identification and location information knowledge base may be combined.

Location fixing means 1, such as a GPS receiver, reports the current location of the vehicle. The location of the vehicle is updated at intervals by data received by location fixing means 1. When the current location of the vehicle is determined by location fixing means 1 this information is passed to commentary point identification means 2. Commentary point identification means 2 queries local information knowledge base 6 to determine if there is a commentary for the current location. Local information knowledge base 6 contains information on which points on the current route are associated with commentaries. If commentary point identification means 2 identifies that there is a commentary associated with the current location it sends a signal to control function 3. Upon receipt of a signal from commentary point identification means 2 control function 3 retrieves the relevant commentary from commentary storage means 7. Control function 3 passes the retrieved commentary to comment reproduction means 4. Commentary reproduction means 4 applies any language selection required to the commentary and combines any commentary material required from external media inputs 11 and then passes the commentary to commentary distribution means 5 for distribution to passengers 4 Commentary point identification means, location information knowledge base, commentary storage means, the central control function, performance and journey logging and commentary reproduction means may be part of a software system stored in a computing device such as a microprocessor, microcontroller or the like.

The mechanism by which the commentary system determines when to play a commentary may be an adaptive process based on combinations of inputs, internal and external to the system. The triggering system may include state machines that can be used to react to the past history of the passenger in the vehicle. For example to not play the same commentary twice if passing the same location again. These state machines can be defined as part of the location information knowledge base 6. Other inputs to determine the commentary actions performed include language selection, locations, optionally including altitude, route history, direction of travel, time of day, day of week, month, year, season, daylight hours, state machines of sequences or other locations, time since other events, the finish of other commentaries, and personal preference of the passengers.

In vehicles where passengers spend a substantial portion of their time seated, for example coach travel or helicopters there may be a shared or individual distribution system. Shared public address speakers and visual monitors can provide a shared audio and/or visual experience. An alternative distribution system is to provide individual headsets which may be networked or individually wired. Individual headsets may be combined with options for individual control of preferences for individual commentary channels. In some systems the individual distribution and settings may be grouped into categories providing limited customisation and fewer channels than passengers.

The commentaries available may include audio including voice, sound effects and music, visual including still and moving images, real and/or graphical images or a synchronised combination of audio and visual commentaries.

An audio commentary may be provided through speakers in the vehicle so that all passengers hear the same commentary Alternatively passengers may be provided with individual speakers or headsets to allow the passengers the choice of listening to the commentary or not. If individual headsets are provided then preferably settings are provided to allow a passenger to input the history of travel, preferred language, route taken and type of commentary preferred.

The commentaries available may include historical information, historical perspectives, myths and legends, re-enactments of important events, recorded historic news, attraction information, guidance information, route information and local marketing. Preferably a passenger can choose a commentary or group of commentaries from those available.

The operator input and display 10 can be as little as a single switch in simple forms of the invention. In more complex forms, for example in motor home use, the unit may be a fill interactive display including route finding and prompting and/or video/graphics.

Commentary reproduction means 4 may include decompression of compressed audio or video commentaries as required, The commentary distribution means 5 delivers events to the passengers. This may include shared displays, individual wired, networked or wireless personal displays, for example FM headsets.

Update means 9 optionally allows wired or wireless communication with the mobile unit for update of databases, software, commentaries and retrieval of log information. If update means 9 is arranged to received wireless communication form a remote device commentaries etc may be updated for the vehicle at any time. Allowing for remote wireless updates means all vehicles in a fleet may be their commentary system updated quickly without the need to be at a certain location, for example a bus station, for the update to occur. Alternatively update means 9 may be a like to a connector for connection to an external update means such as a computer to provide the updates. Optional vehicle data transmission block 13 communicates with remote receivers. This provides information, for example estimated time of arrival information based on information held in the mobile unit.

Commentary storage on the mobile unit may be in several forms or in combination. Internal storage may be provided on hard drive, RAM, analogue or digital storage, removable media, eg CD, DVD, minidisk. External storage may be combined to use external media sources, such as existing video players in synchronism with presentation of internal commentary. The commentary information itself is stored in a format appropriate to the media represented, for example analogue or digitally encoding sound, textual and data representation of visual information, MPEG or other compression techniques for commentary material may be employed.

Embodiments for commuter vehicles can additionally include more traditional station announcements combined with for example direction of travel information. Optionally the mobile unit can use current location information and derived trends to statistically or adaptively predict time of arrival information. This information can be optionally displayed locally.

Location and derived information such as estimated time of arrival from the mobile unit can be optionally transmitted to remote locations, for example to provide estimated time of arrival information to train stations.

The mobile unit optionally monitors its own performance using performance and journey logging means 8. Logs of this performance may be retrieved from time to time and used to improve the commentary system. These logs may optionally include route information including, times, locations, preferences, starts, stops statistics on travel.

Retrieval of this information may be by direct connection to the mobile unit or by wireless means, for example through update means 9.

The mobile unit is optionally supported by the non-mobile components of the system. Such components provide means of initialising the mobile unit with commentary databases, including routes, location information and media for commentaries. Components provide means for retrieval of the log information, interpretation of this information, transfer to external systems For example information on the effectiveness of included or external marketing may be extracted and transferred to other general purpose systems.

Interpretation of logs may include diagnostic interpretation and testing.

Vehicles categories in which the invention can be fitted include, but are not limited to, cars, motor homes, busses, coaches, planes, helicopters, boats, trains and trains.

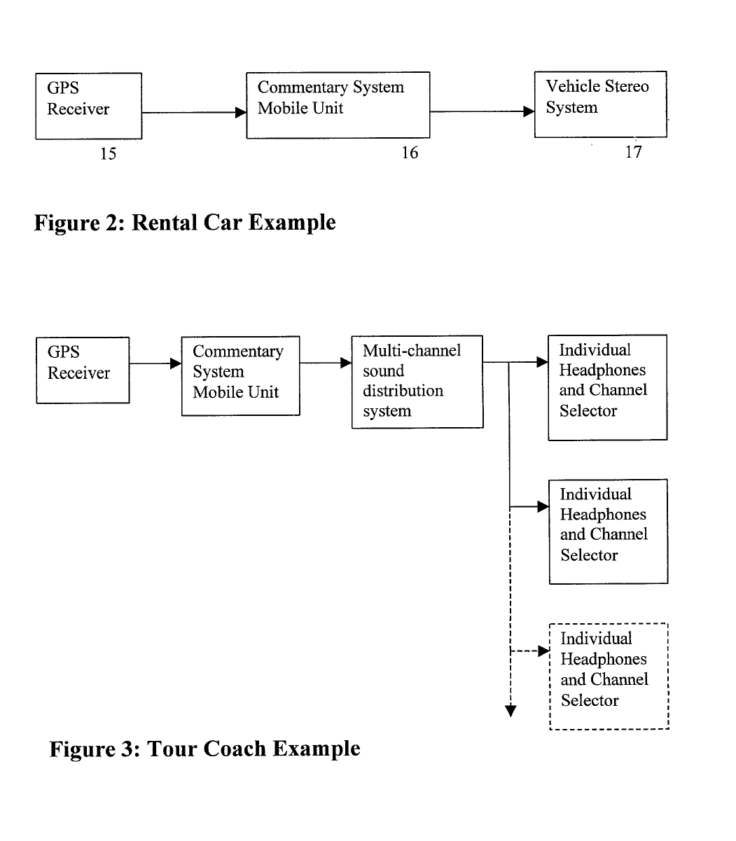

FIG. 2 shows an embodiment of the invention arranged for rental vehicles with existing stereo systems. Distribution of the commentaries depends on the embodiment and application. An embodiment for rental vehicles involves provision of stereo audio through the pre-existing sound system, either by direct connection, or indirectly for example by modulation onto a radio channel available to the vehicle's radio. GPS receiver 15 provides location information to commentary system mobile unit 16. This unit performs the same functions of determining whether the location has an associated commentary and providing the commentary information to vehicle stereo system 17 as the commentary point identification means, location information knowledge base, control function, commentary storage and commentary reproduction means of FIG. 1.

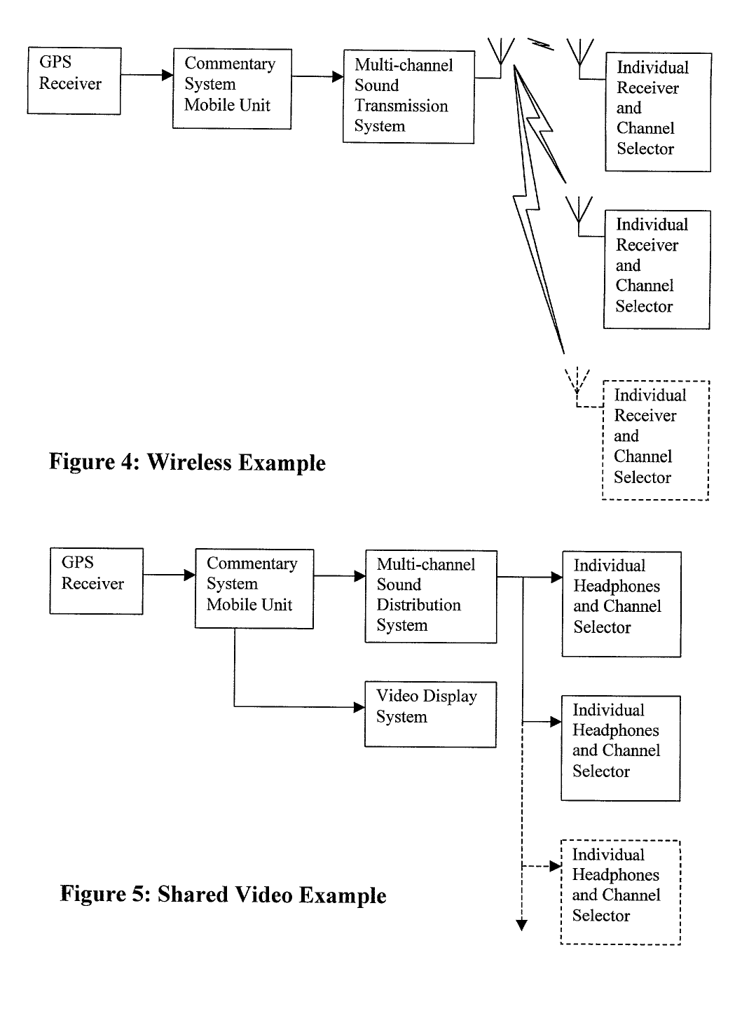

FIGS. 3, 4 and 5 show embodiments of the invention arranged for use in tour coaches. These figures all show GPS receivers coupled to commentary system mobile units of the type described with reference to FIG. 1 and multi-channel commentary distribution systems. The channel distribution systems may be wired or wireless allowing passengers' individual headsets and channel selection. The channel selection may allow each passenger to select the language in which they want to listen to the commentary or other personalised preference. The triggering of commentary events may be based on any combination of current location, direction of travel, previous locations and route history, derived trends, time duration, time of day, day of week, day of month, month, year, season, daylight hours, proximity to a location and preference settings.

With individual headsets each passenger may adjust the volume on their headset. FIG. 5 shows the system with a common visual display unit. The display unit may provide visual display with synchronised or simultaneous presentation of any combination of speech, audio, sound effects, music, video still or moving graphical or photographically derived images. Alternatively each passenger may be provided with a visual display unit. In a coach situation a central control console may be provided which allows customisation optionally including route planning and/or prompting.

Such systems may also include data logging means to provide information for updating commentaries for example. Transmission of estimated times of arrival may also occur such as at coach stops or train stations.

A preferred implementation unit of the invention has a single stereo audio output with selectable language capability. Location fixing is accomplished with a connection to a GPS device. The control function is implemented as software running on general purpose computer hardware under a real-time operating system. Commentary storage is on computer hard drive in digital compressed format. Performance and activity logging data is stored directly to proprietary format data files on the computer hard drive. Update information, service changes and log retrieval are achieved by Ethernet connection. Operator interfacing on the mobile unit is limited to language selection and tour restart button.

The foregoing describes the invention including a preferred for thereof. Alterations and modifications as will be obvious to those skilled in the art are intended to be incorporated within the scope hereof as defined in the accompanying claims.

1. A method for providing cornmentary to one or more passengers in a moving vehicle including the steps of:
periodically or continuously determining the present location of the vehicle as the vehicle moves through or in a geographic area,
assessing whether items of commentary related to different parts of the geographic area are available as the vehicle passes through different parts of the geographic area, from a number of stored items of commentary related to different parts of the geographic area, and
playing a commentary to the passenger(s) consisting of a series of selected items from said stored items of commentary.

2. A method for providing commentary to passengers in a vehicle according to claim 1 further including the step of determining whether a selected item of commentary has already been played to the passenger(s) before playing the item.

3. A method for providing commentary to one or more passengers in a moving vehicle according to claim 2 including also playing items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

4. A method for providing commentary to passengers in a vehicle according to claim 3 further including allowing a passenger or passengers to select a language in which to receive the commentary.

5. A method for providing commentary to one or more passengers in a moving vehicle including the steps of:
periodically or continuously determining the present location of the vehicle as the vehicle moves through or in a geographic area via a GPS receiver on the vehicle,
assessing whether items of commentary related to different parts of the geographic area are available as the vehicle passes through different parts of the geographic area, from a number of stored items of commentary related to different parts of the geographic area, and
playing a commentary to the passenger(s) consisting of a series of selected items from said stored items of commentary.

6. A method for providing commentary to passengers in a vehicle according to claim 5 further including the step of determining whether a selected item of commentary has already been played to the passenger(s) before playing the item.

7. A method for providing commentary to one or more passengers in a moving vehicle according to claim 6 including also playing items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

8. A method for providing commentary to passengers in a vehicle according to claim 7 further including allowing a passenger or passengers to select a language in which to receive the commentary.

9. A system for providing commentary to one or more passengers in a moving vehicle including:
means arranged to periodically or continuously determine the present location of the vehicle as the vehicle moves through or in a geographic area,
means arranged to assess whether items of commentary related to different parts of the geographic area are available as the vehicle passes through different parts of the geographic area, from a number of stored items of commentary related to different parts of the geographic area, and
means arranged to play a commentary to the passenger(s) consisting of a series of selected items from said stored items of commentary.

10. A system for providing commentary to one or more passengers in a moving vehicle according to claim 9 also arranged to play items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

11. A system for providing commentary to passengers in a vehicle according to claim 10 arranged to play audio commentaries.

12. A system for providing commentary to passengers in a vehicle according to claim 11 arranged to play video commentaries.

13. A system for providing commentary to passengers in a vehicle according to claim 12 wherein the system is arranged to play commentaries through a central speaker or speaker and video display system to a number of passengers.

14. A system for providing commentary to passengers in a vehicle according to claim 12 wherein the system is arranged to play commentaries through one or more headphone or headphone and video display devices to one or more passengers individually.

15. A system for providing commentary to passengers in a vehicle according to claim 14 wherein the system is arranged to be able to simultaneously play the same commentary in different languages to different devices.

16. A system for providing commentary to passengers in a vehicle according to claim 15 wherein the system is arranged to allow passengers a selection of languages in which to hear the commentaries.

17. A system for providing commentary to passengers in a vehicle according to claim 13 wherein the system is arranged to allow passengers a selection of languages in which to hear the commentaries.

18. A system for providing commentary to one or more passengers in a moving vehicle including:
means arranged to periodically or continuously determine the present location of the vehicle as the vehicle moves through or in a geographic area,
means arranged to assess whether items of commentary related to different parts of the geographic area are available as the vehicle passes through different parts of the geographic area, from a number of stored items of commentary related to different parts of the geographic area,
means arranged to play a commentary to the passenger(s) consisting of a series of selected items from said stored items of commentary, and
means arranged to receive information from a remote transmitter.

19. A system for providing commentary to one or more passengers in a moving vehicle according to claim 18 also arranged to play items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

20. A system for providing commentary to passengers in a vehicle according to claim 19 arranged to play audio commentaries.

21. A system for providing commentary to passengers in a vehicle according to claim 20 arranged to play video commentaries.

22. A system for providing commentary to passengers in a vehicle according to claim 21 wherein the system is arranged to play commentaries through a central speaker or speaker and video display system to a number of passengers.

23. A system for providing commentary to passengers in a vehicle according to claim 21 wherein the system is arranged to play commentaries through one or more headphone or headphone and video display devices to one or more passengers individually.

24. A system for providing commentary to passengers in a vehicle according to claim 23 wherein the system is arranged to be able to simultaneously play the same commentary in different languages to different devices.

25. A system for providing commentary to passengers in a vehicle according to claim 24 wherein the system is arranged to allow passengers a selection of languages in which to hear the commentaries.

26. A system for providing commentary to passengers in a vehicle according to claim 22 wherein the system is arranged to allow passengers a selection of languages in which to hear the commentaries.

27. A system for providing commentary to one or more passengers in a moving vehicle including:
means arranged to periodically or continuously determine the present location of the vehicle as the vehicle moves through or in a geographic area,
means arranged to assess whether items of commentary related to different parts of the geographic area are available as the vehicle passes through different parts of the geographic area, from a number of stored items of commentary related to different parts of the geographic area, and
means arranged to play a commentary to the passenger(s) consisting of a series of selected items from said stored items of commentary, and
means arranged to store vehicle data.

28. A system for providing commentary to one or more passengers in a moving vehicle according to claim 27 also arranged to play items of information or music to the passenger(s) when there is no item in said stored items which relates to the part of a geographic area through which the vehicle is moving or when a stored item relating to the part of a geographic area through which the vehicle is moving has previously been played to the passenger or passenger(s).

29. A system for providing commentary to passengers in a vehicle according to claim 28 arranged to play audio commentaries.

30. A system for providing commentary to passengers in a vehicle according to claim 29 arranged to play video commentaries.

31. A system for providing commentary to passengers in a vehicle according to claim 30 wherein the system is arranged to play commentaries through a central speaker or speaker and video display system to a number of passengers.

32. A system for providing commentary to passengers in a vehicle according to claim 30 wherein the system is arranged to play commentaries through one or more headphone or headphone and video display devices to one or more passengers individually.

33. A system for providing commentary to passengers in a vehicle according to claim 32 wherein the system is arranged to be able to simultaneously play the same commentary in different languages to different devices.

34. A system for providing commentary to passengers in a vehicle according to claim 33 wherein the system is arranged to allow passengers a selection of languages in which to hear the commentaries.

35. A system for providing commentary to passengers in a vehicle according to claim 31 wherein the system is arranged to allow passengers a selection of languages in which to hear the commentaries.

36. A system for providing commentary to one or more passengers in a moving automobile, buss motorhome, or air or marine craft (herein: vehicle), including means arranged to monitor the location of the vehicle as it travels through or in a geographic area, and means arranged to play a pre-recorded commentary related to the current location of the vehicle to the passenger(s).

37. A system for providing commentary to passengers according to claim 36 wherein the commentary includes discrete items of commentary information, the playing of each of which is separately initiated when the means arranged to monitor the location of the vehicle indicates that the vehicle is in a part of the geographic area to which an individual item of commentary information relates.

38. A system for providing commentary to passengers in a vehicle according to claim 37 wherein the commentary is an audio or an audio and video commentary.

39. A system for providing commentary to one or more passengers in a moving automobile, bus, motorhome, or air or marine craft (herein: vehicle), including GPS receiver means on board the vehicle arranged to monitor the location of the vehicle as it travels through or in a geographic area, and means arranged to play a pre-recorded commentary related to the current location of the vehicle to the passenger(s).

40. A system for providing commentary to passengers according to claim 39 wherein the commentary includes discrete items of commentary information, the playing of each of which is separately initiated when the means arranged to monitor the location of the vehicle indicates that the vehicle is in a part of the geographic area to which an individual item of commentary information relates.

41. A system for providing commentary to passengers in a vehicle according to claim 40 wherein the commentary is an audio or an audio and video commentary.
